(19) United States
(12) Patent Application Publication
(10) Pub. No.: US 2002/0134387 A1
(43) Pub. Date: Sep. 26, 2002

(54) Automatic underwater breathing membrane with integrated manual recharge

(76) Inventors: Andre-Pierre Saurat, Charbonnieres (FR); Philippe Michel, Echirolles (FR)

Correspondence Address: GREENBLUM & BERNSTEIN, P.L.C., 1941 ROLAND CLARKE PLACE, RESTON, VA, 20191, US

(21) Appl. No.: 09/926,753

(22) PCT Filed: Apr. 27, 2001
(86) PCT No.: PCT/FR01/01328

(30) Foreign Application Priority Data
May 4, 2000 (FR) 0005737

(51) Int. Cl. F17C 1/00; A62B 7/00

(52) U.S. Cl. 128/205.22; 220/581

(57) ABSTRACT

The present invention relates to an individual subaquatic diving apparatus with self-contained recharging. This apparatus is constituted of a bottle pressurized with air by means of a manual pump integrated into the bottle or of a filler valve.

This apparatus comprises a retention assembly that adapts to the back of the diver. The air under pressure in the bottle is transmitted to the diver via a hose and a single-stage pressure reducing valve that adjusts the suction pressure to the ambient pressure of the water. The pump integrated into the bottle is a high performance pump that makes it possible to reach a recharging capacity of several tens of bars without undue efforts.

This manual pump with two chambers considerably improves the ratio between pressure, air flow, and the force exerted on the handle of the pump with respect to a conventional single-body pump.

The present invention relates to a self-contained subaquatic breathing system comprising especially a bottle of compressed air which integrates its own air refill means using a manually driven pump.

In the known subaquatic breathing systems, the diver can be supplied with compressed air either from the surface, as in the case of a diving suit having a helmet and a cable, or by means of a bottle of compressed air carried by the diver.

The systems for recharging diving bottles of compressed air use compressors with powerful thermal or electric motors which make it possible to bring the internal pressure of the bottle close to 200 bars. This has the advantage of offering a substantial self-contained breathing capability underwater, but has very restricting drawbacks:

Necessity to refill the bottle after diving for about 40 minutes.

Numerous locations worldwide are not equipped with compressors, which renders this technique inoperative.

The diver must carry a heavy and cumbersome equipment.

It is necessary to use the bottle within a predetermined period of time after being refilled, otherwise the air quality deteriorates.

According to pressure device regulations, the high pressure inside the diving bottles requires an annual check of the latter.

The present invention relates to the recharging of the bottle of compressed air. The object is to overcome the aforementioned disadvantages.

To achieve this object, the present invention provides a subaquatic self-contained breathing apparatus of the aforementioned type. It is characterized particularly in that the bottle can be pressurized with air by means of an integrated manual pump. Located within the bottle, it makes it possible to pressurize the latter substantially to about ten bars.

This bottle further comprises a charge and discharge valve. This apparatus is equipped with a retaining assembly which adapts to the back of the diver. The air under pressure in the bottle is transmitted to the diver via a hose and a single-stage pressure reducing valve that adjusts the suction pressure to the ambient pressure of the water.

To facilitate the immersion of the diver, the subaquatic self-contained breathing apparatus has a mass substantially equal to its volume multiplied by the density of the water in which he is submerged.

The main advantage of the subaquatic self-contained breathing apparatus according to the invention lies in that it makes it possible to refill the bottle with compressed air without using a compressor.

Thus, it will find a useful application in areas where there are no compressors, such as the beach, the pool, or aboard a ship (checking the hull, unhooking of the anchor at minimal depth), on the one hand, and as a complement to the currently available diving equipment in order to undertake “spare time” short range dives.

Thus, the diver wishing to undertake a dive pumps for a few minutes to charge the bottle with compressed air at a pressure of 5-15 bars. He will have an autonomy of about ten minutes underwater, which can vary depending on the depth and his air consumption.

According to one embodiment of the present invention, the bottle is cylindrical. The lower end, due to its flared shape, makes it possible to stabilize said bottle in the vertical position; the upper portion comprises a wide circular opening which makes it possible to insert the pump and to fix it on the latter. Said bottle must be able to withstand the outside water pressure as well as the internal air pressure.

The pump integrated into the bottle is a high performance pump which makes it possible to achieve a charging capacity of several tens of bars without undue force.

According to one embodiment of the present invention, the pump is fixed to the upper portion of the bottle by means of a flange. Said pump is actuated in the vertical direction by means of a handle.

The pump includes a circular plate associated with at least one pump body; said plate is positioned on the upper opening of the bottle, the sealing between the opening and the plate is ensured by an o-ring. The plate is maintained pressed against the opening due to a circular flange screwed on the outer contour of the opening.

According to a first embodiment of the present invention, the pump is characterized in that it includes: a primary chamber and a secondary chamber arranged geometrically parallel to one another, each chamber receiving a simultaneously movable piston. Each piston is actuated by a rod which is itself connected to a single operating handle. The rod of the piston of the primary chamber is hollow so as to enable air intake beneath the piston.

The end connected to the handle of said rod comprises at least one transverse opening in order to enable air intake in the hollow rod. The longitudinal positioning of said opening on the rod is located substantially at the level of or beneath the sealing joint when the pump is in the locked position in order to avoid water infiltration through this opening during the dive. As a result, the pump must be locked before immersion.

The two chambers communicate at their upper ends by one or several openings or channels so as to permit the transfer of air from the primary chamber toward the secondary chamber.

The secondary chamber comprises a lower opening provided with a non-return valve enabling the injection of air into the bottle. The movable piston in the primary chamber is oriented so as to enable the intake into this primary chamber and its delivery in the secondary chamber, whereas the movable piston in the secondary chamber is oriented so as to enable the intake of air coming from the primary chamber and its delivery in the bottle through the non-return valve.

According to one embodiment of the present invention, the handle that connects and allows to simultaneously actuate the two rods must make it possible to refill the bottle with both hands, on the one hand, and to comfortably carry the bottle, on the other hand. A locking system makes it possible to lock the handle in the low position.

The double body pump system makes it possible to improve the ratio between the number of pump strokes and the forces to exert on the handle in relation to a single body pump.

According to another embodiment of the present invention, a single body pump provided with a sealing joint between the bottle cap and the piston rod is used. The air intake rests on the same hollow rod principle, but whose lower opening must emerge above the piston.

According to one embodiment of the invention, the subaquatic self-contained breathing apparatus comprises a depth checking system which will reduce the air flow of the pressure reducing valve from a predetermined depth.

According to one embodiment, the subaquatic self-contained breathing apparatus is equipped with a watertight pressure gauge making it possible to monitor the change in the air pressure in the bottle both during immersion and during the refill. This pressure gauge is either fixed on the bottle or detachably connected to the charge and discharge valve via a flexible cord.

This pressure gauge makes it possible to inform the diver about the remaining self-contained breathing capability, which enables him to anticipate when to go back to the surface.

According to one embodiment of the present invention, the subaquatic self-contained breathing apparatus is equipped with a pressure reducing valve making it possible to deliver to the diver a breathing air pressure that is substantially equal to the water ambient pressure, whereas the pressure inside the bottle varies during the dive from ten bars to 1 bar.

Thus, this pressure reducing valve is of the standard two-stage type that is used on conventional diving bottles, complementary to a first-stage pressure reducing valve.

Since the internal low pressure of the bottle does not justify the use of a first stage pressure reducing valve, the pressure reducing valve is directly connected to the bottle of compressed air with a quick coupler and a hose. When the internal pressure of the bottle is substantially equal to the water ambient pressure, breathing becomes more difficult, which informs the diver that he must go back to the surface.

According to one embodiment of the present invention, the subaquatic self-contained breathing apparatus comprises a dorsal retaining assembly of the “shoulder straps” type, constituted of two straps fixed to the two ends of the bottle, ensuring the vertical retention thereof on the diver's back, on the one hand, and of a front “belt” strap enabling the horizontal stability of the bottle.

According to one embodiment of the present invention, the bottle of compressed air is fixed on a jacket used for retention on the diver's back. Said jacket is constituted of one or several inflatable pockets making it possible to act on the buoyancy of the diver.

According to one embodiment of the present invention, the bottle of compressed air includes a retaining foot enabling said bottle to be stabilized during charging. By placing his feet on these appendices, the diver can thus keep the bottle pressed to the ground. During the dive, these appendices are either retracted within a support in order not to hinder the diver's movements, or folded back along the bottle.

The annexed drawings illustrate the invention:

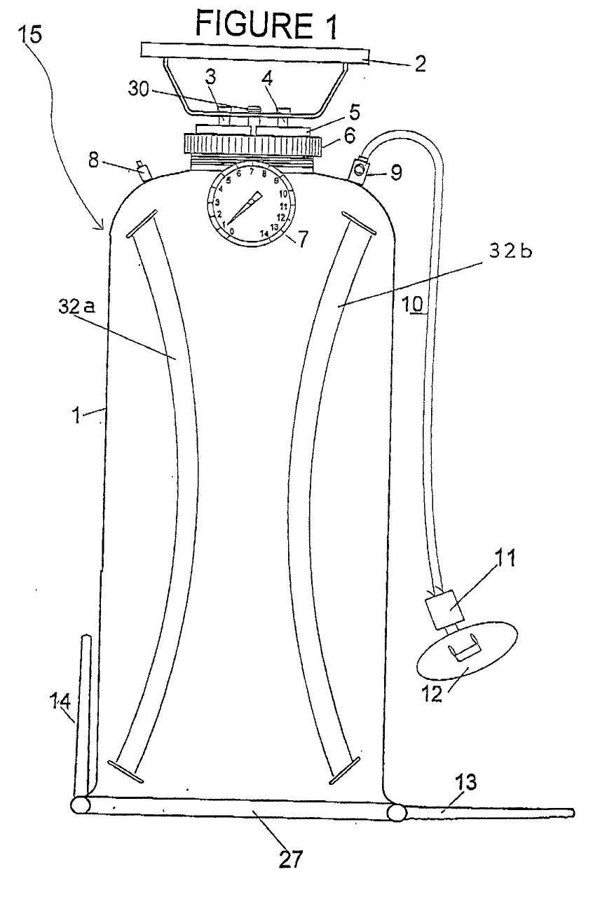

FIG. 1 is a schematic view of the main elements constituting the self-contained breathing apparatus with integrated recharging.

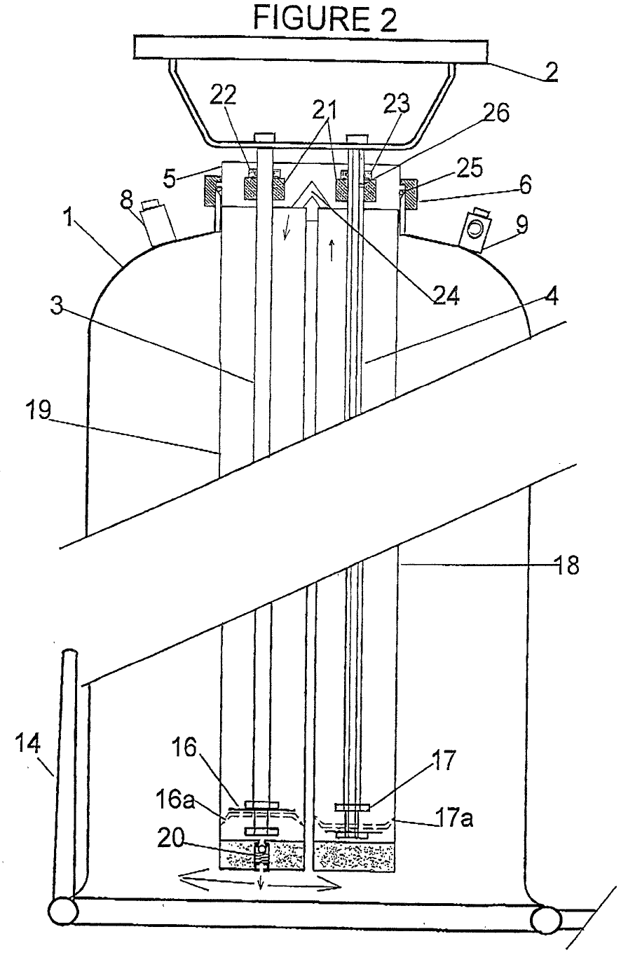

FIG. 2 is a cross-sectional view of the double body pump positioned within the bottle.

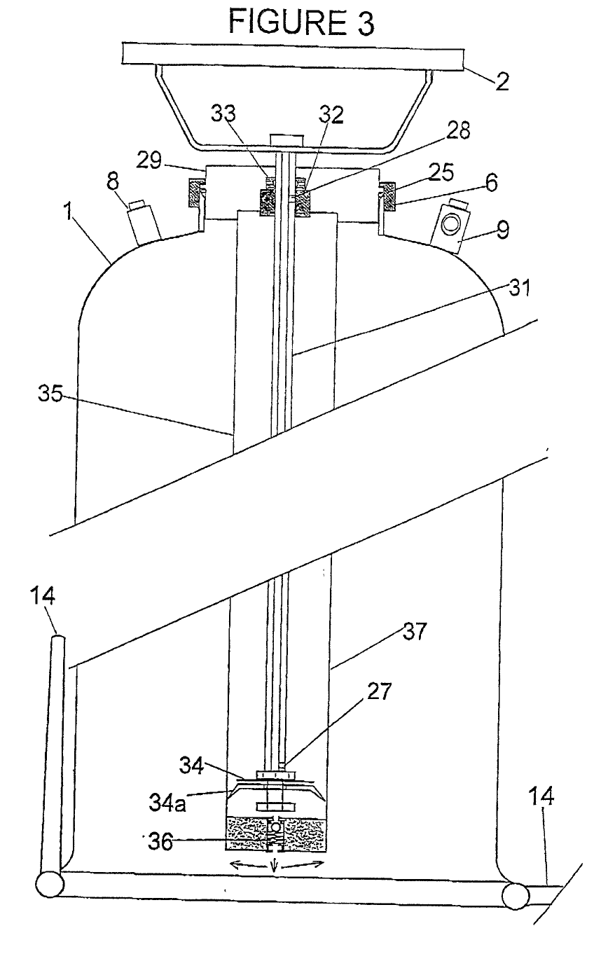

FIG. 3 is a cross-sectional view of the single body pump positioned within the bottle.

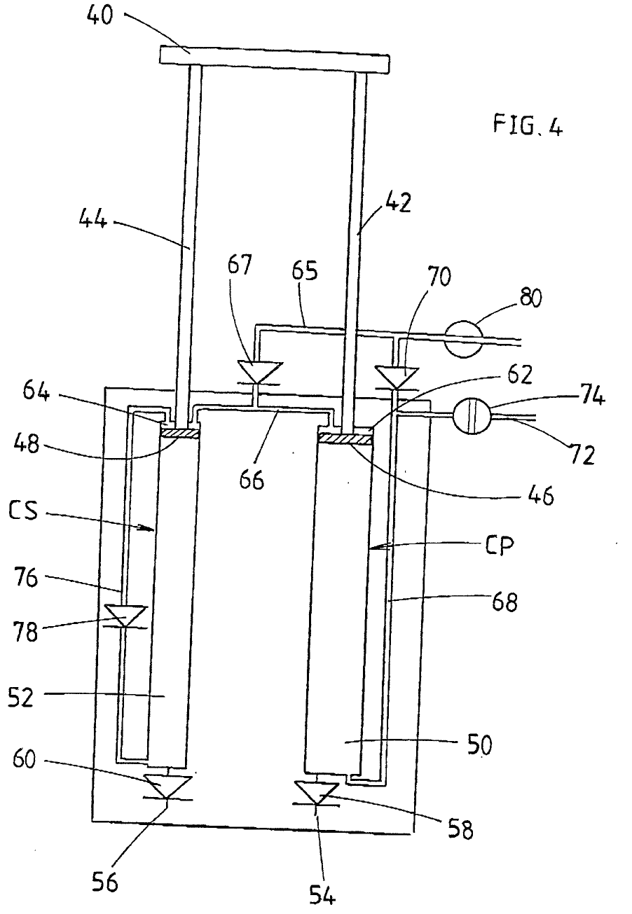

FIG. 4 is a schematic cross-sectional view of the self-contained breathing apparatus provided with an alternative embodiment of the double body pump.

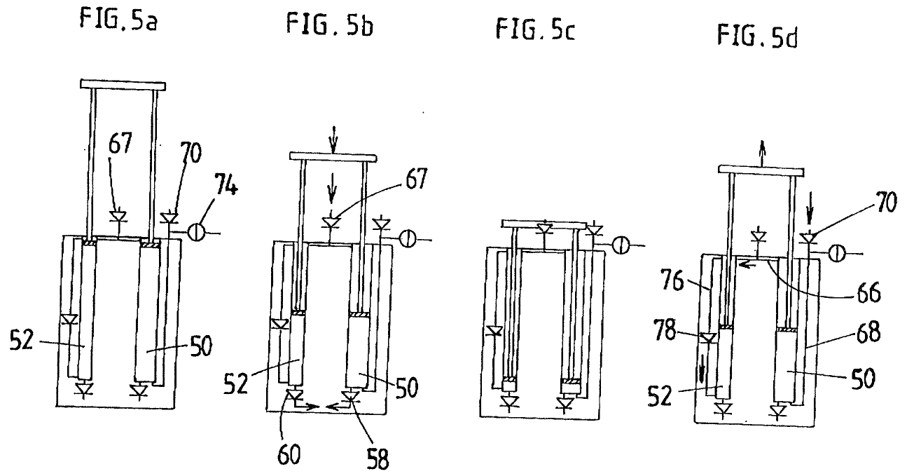

FIGS. 5A-5D illustrate various operating steps of the pump shown in FIG. 5, in a first operating mode of the pump.

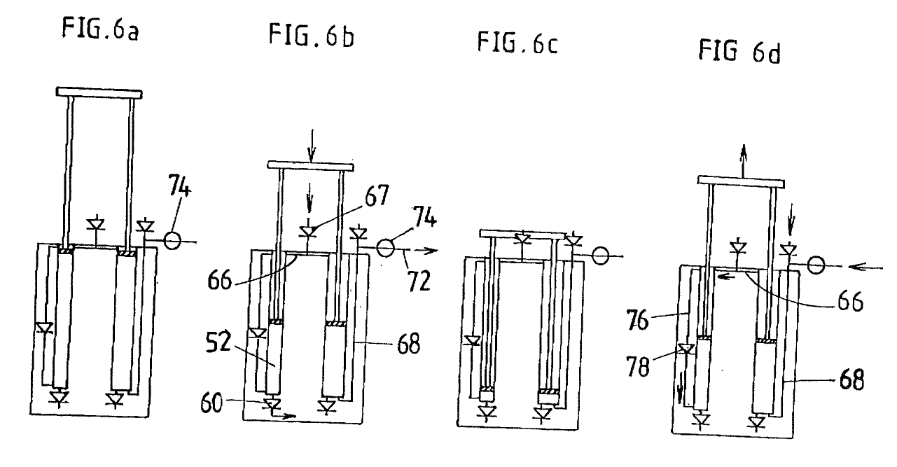

FIGS. 6A-6D illustrate various operating steps of the pump of FIG. 5, in a second operating mode of the pump.

In the general representation of FIG. 1, we have schematically shown the subaquatic self-contained breathing apparatus (15) including a bottle (1) of compressed air, to the top of which is connected, by means of a quick coupler (9), an air supply hose (10) to the end of which is connected the pressure reducing valve (12) inserted in the mouth by the diver at the time of immersion. By bottle is meant an air tank of any form under pressure adapted to be carried under water by the diver during the dive.

A depth checking system (11) which, for example, reduces the air flow of the pressure reducing valve from a predetermined depth, is fixed on the air supply conduit.

A charge and discharge valve (8) is fixed to the upper portion of the bottle.

The fixing of the piston holding rods (3) and (4) in the retracted position in the pump bodies (18) and (19) is ensured by a locking system (30) which makes it possible to affix the handle (2) to the plate (5) when necessary.

At the base of the bottle (1) is a retention foot constituted of a support (27) within which are two telescopic or foldable appendices (13), (14), in order to provide the bottle with a greater vertical stability during the refill of the bottle with air using the pump.

To the top and base of the bottle (1) are fixed two vertical straps (32a, 32b) that form a carrying system enabling the diver to carry the bottle on his back during the dive.

In the embodiment according to FIG. 2, the pump includes two parallel bodies (18) and (19) of equal lengths, arranged side by side. These bodies are blocked at the upper portion by an upper plate (5) which further constitutes the cap of the bottle (1).

The lower end of the primary pump body (18) is completely blocked, whereas that of the secondary pump body (19) comprises a lower opening for air injection provided with a non-return valve (20).

The two pump bodies (18), (19) are thus affixed to the bottle (1) via the plate (5).

The pump body (18) constitutes a primary chamber CP, whereas the pump body (19) constitutes a secondary chamber CS, the two chambers can have different cross-sections.

The primary chamber CP houses a piston, generally designated by the reference numeral (17), of the cup type having a deformable lip (17a), which is fixed at the end of a piston holding rod (4) extending through the upper plate (5). A joint (23) as well as a guiding ring (21) are housed in the upper plate (5) to obtain tightness and guidance between the latter and the piston holding rod (4).

The secondary chamber CS also houses a cup-type piston (16) including a deformable lip (16a) which is fixed at the end of a piston holding rod (3) extending through the upper plate (5). A joint (22) as well as a guiding ring (21) are housed in the upper plate (5) to obtain tightness and guidance between the latter and the piston holding rod (3).

The aforementioned piston holding rods (3), (4) extend beyond the upper plate (5), coupled to a single operating handle (2); therefore, the pistons (16) and (17) are simultaneously driven in a to-and-fro motion within the chambers CP and CS.

The pistons (16) and (17) are substantially at the same level within each of the chambers, such that they are both together at a low point or at a high point, but the lips (16a) and (17a) of the cups are inverted; more specifically, the lip (17a) of the piston (17) of the primary chamber CP is turned upward, i.e., toward the plate (5), whereas the lip (16a) of the piston (16) of the secondary chamber CS is turned downward, i.e., toward the bottom of the body (19).

The two chambers CP and CS are in communication in the upper portion by means of a channel (24), for example, whereas in the lower portion, the chamber CS is in communication with the inside of the bottle via a lower opening (20) provided with a non-return valve. The rod (4) that holds the piston of the primary chamber is hollow along its entire length, its lower opening emerging beneath the piston (17), whereas its upper end is sealed. In this way, the two chambers (CP, CS) are functionally arranged in series.

The air intake is done via a transverse opening (26) that is positioned at the level of or beneath the sealing joint when the pump is locked in the low position, but above the sealing joint when the rod (4) is displaced upward, so as to place the primary chamber in communication with the atmosphere.

The plate (5) is pressed on the opening of the bottle (1) due to a circular flange (6) screwed on the outer contour of the opening; the sealing between the opening and the plate (5) is ensured by an o-ring (25).

In the embodiment of FIG. 2, the cups (16a, 17a) of the two pistons (16, 17) therefore divide the inside of the pump body into three compartments whose respective volumes vary as a function of the position of the pistons. The first compartment is that (forming an outlet cavity) demarcated beneath the cup (17a) in the primary chamber (CP). The second compartment includes the upper portions (or transfer cavities) of the primary and secondary chambers, i.e., those located above the corresponding cups (16a, 17a). These two portions are indeed connected by the channel (24) so as to form a single compartment in which pressure is always uniform. The third compartment is that located beneath the cup (16a) of the secondary chamber (CS) (and forming an outlet cavity for the secondary chamber).

When the pistons (16, 17) are moved upward, i.e., when the volume of the first compartment increases, the air coming from the outside is admitted into the first compartment, through the hollow rod (4).

When the pistons (16, 17) are actuated downwardly, it is the volume of the second compartment that increases. The air previously contained in the first compartment can be transferred toward the second compartment due to the orientation of the lip of the cup (17a). As the final volume of the second compartment is substantially double the initial volume of the first compartment, outside air can also be admitted into the second compartment during this phase, this outside air transiting by the hollow rod (4), by the first compartment and by the cup (17a).

When the pistons (16, 17) are again driven upwardly, the volume of the second compartment decreases; therefore, the pressure of the air contained therein tends to increase. In view of the orientation of the cups (16a, 17a), which form a non-return system, air cannot return toward the first compartment, which is filled with fresh air coming from the outside, as has been explained hereinabove. Thus, as the pistons move upward, the air contained in the second compartment is pushed toward the third compartment, which is made possible by the orientation of the lip of the cup (16a). However, the final volume of the third compartment is substantially two times smaller than the initial volume of the second compartment. As a result, when the pistons reach their high position, the pressure of the air contained in the third compartment is higher than the initial pressure. During the upward motion of the pistons, a first stage of compression occurs during the transfer of air from the second to the third compartment.

During the downward motion of the pistons, the volume of the third compartment decreases, which undertakes a second stage of compression of the air contained in the third compartment. When pressure in the third compartment exceeds a limit pressure, which is a function of the pressure in the bottle and of the calibration of the non-return valve, the air under pressure is evacuated toward the inside of the bottle through the lower opening (20), without any possibility of return.

The double piston construction therefore makes it possible to undertake a compression in two stages. The compression ration of the first stage can be changed by modifying the respective volumes of the primary and secondary chambers. Thus, with a secondary chamber having a smaller diameter than the primary chamber, one obtains a higher compression ratio for the first stage of compression. The pumping system with two stages of compression that is used here is particularly advantageous for it makes it possible to reduce the time necessary for the refill of the bottle. Of course, a pumping system with multiple compression stages can be provided, comprising, for example, a pump provided with as many successive bodies as the desired compression stages.

In the embodiment according to FIG. 3, the pump includes a single body (37) blocked at the upper portion by a plate (29) which further constitutes the cap of the bottle.

The lower end of the pump body (37) is blocked but comprises an opening for air injection provided with a non-return valve (36).

The pump body (37) receives a cup-type piston (34) including a deformable lip (34a), which is adapted to the end of piston holding rod (31) extending through the plate (29). A joint (33) as well as a guiding ring (32) are housed in the plate (29) for obtaining tightness and guidance between the latter and the piston holding rod.

The deformable lip (34a) of the piston (34) is turned toward the bottom of the pump body so that it can push back the air in this direction.

The aforementioned piston holding rod (31) extends beyond the plate (29), coupled to a single operating handle (2).

The rod (31) is hollow along its entire length, its lower opening (27) is transverse to the rod and emerges right above the piston (34), whereas its upper end is sealed.

The air intake is carried out via a transverse opening (28) substantially positioned beneath the sealing joint when the pump is locked in the low position.

In this second embodiment, the outside air is admitted into the upper portion of the pump body when the piston (34) is brought from its high position to its low position. It is then transferred toward the lower portion of the pump body, by passing through the cup (34a), when the piston (34) is brought from its low position to its high position. When the piston is again brought toward its low position, the air contained in the lower portion is compressed, and, beyond a limit pressure, it is transferred toward the inside of the bottle.

This embodiment of the pumping system only offers a single pumping stage, but it has the advantage of being very simple and very inexpensive.

In the embodiment of FIGS. 4, 5A-5D, and 6A-6D, the self-contained breathing apparatus according to the invention comprises an improved pumping system. Indeed, as the embodiment of FIG. 2, it is a two-body pumping system capable of performing a two-stage compression. However, the embodiment of FIG. 2 only comprises one outlet cavity (i.e., a cavity in which the air is subject to a last compression before being discharged toward the tank) whereas in this third embodiment, the pumping system comprises two outlet cavities which can be activated simultaneously, or one of which can be deactivated.

As in the embodiment of FIG. 2, the pump comprises two primary (CP) and secondary (CS) cylindrical chambers arranged geometrically parallel to one another, each chamber housing a piston (46, 48) mounted at the end of an axially movable rod (42, 44), the two rods being actuated by a common handle (40). The mounting of the pump bodies within the bottle is identical to that described hereinabove.

Contrary to the embodiment of FIG. 2, the pistons (46, 48) are impervious pistons which allow no air passage between the chamber portions which they demarcate. Each chamber thus comprises one air outlet cavity (50, 52) which, in the example of embodiment, is constituted by the lower portion of each of the two chambers, and which comprises an air outlet opening (54, 56) opening out in the bottle. Each outlet opening (54, 56) is associated with a non-return system (58, 60), such as a valve, allowing passage of the air only from the corresponding outlet cavity toward the inside of the bottle.

The other portion of each of the two chambers, in this case the upper portions, constitutes a transfer cavity (62, 64). The two transfer cavities are connected to one another, as previously, by a connecting channel (66) to form a transfer compartment similar to the second compartment of the embodiment of FIG. 2. In this embodiment, the transfer compartment comprises an inlet (65) for air admission, which is carried out through a non-return valve (67). This air inlet (65) opens out, for example, in the connecting channel (66).

The outlet cavity (50) of the primary chamber (CP) is connected to a conduit (68) which enables the admission of air into the outlet cavity (50), through a non-return valve (70) preventing air from going back out. This conduit further comprises a branch (72), between the valve (70) and the outlet cavity (50), which is provided with a closure valve (74), and which makes it possible to place the outlet cavity (50) in constant communication with the atmosphere when the closure valve (74) is open. In this configuration, the outlet cavity (50) of the primary chamber (CP) becomes inoperative.

The non-return valves (67, 70) which allow the air admission into the transfer compartment and in the outlet cavity (50) of the primary chamber (CP) are connected to the atmosphere by a common cut-off valve (80), which makes it possible to isolate them from water during the dive, thus preventing water from entering into the pump body. This valve (80) must be open when the pump is used to recharge the bottle.

Furthermore, the transfer cavity 64 of the secondary chamber is connected to the outlet opening (52) of this same chamber by a transfer pipe (76) in which is inserted a non-return valve (78) allowing the passage of air only from the transfer compartment toward the outlet opening (52). This pipe (76) with a non-return valve, associated with the impervious piston (48), fulfils the same function as the cup-type piston (16a) of the embodiment of FIG. 2.

FIGS. 5A-5D show the functioning of the pumping system of the self-contained breathing apparatus of FIG. 5 according to a first operating mode in which the closure valve (74) is closed.

In this operating mode, the outlet cavity of the primary chamber is active, and it can be noted that it functions independently of the other parts of the pump. Indeed, when the piston (46) rises from its low position toward its high position, the outlet cavity (50) of the primary chamber is filled with air at the atmospheric pressure through the valve (70). When the piston (46) moves in the opposite direction, the compressed air in the outlet cavity (50) cannot escape by the conduit (68) which is closed, and the air is therefore discharged toward the inside of the bottle through the valve (58) and the outlet opening (54).

At the same time, when the pistons move down to their low position, the transfer compartment is filled with air by the valve (67) and, when the pistons (46, 48) rise, the gas previously contained in the transfer compartment is transferred, by the pipe (76), toward the outlet cavity (52) of the secondary chamber (CS).

In this embodiment, the secondary chamber has a volume that is substantially half that of the primary chamber, such that the air that has just been transferred toward the outlet cavity (52) is under an absolute pressure of almost 3 bars, thus obtaining a first stage of compression. When the piston (48) moves downward again, this air is again compressed in the outlet cavity (52) before being discharged toward the inside of the bottle.

In this configuration, the pump, upon each to-and-fro motion, discharges a quantity of air which corresponds, at the atmospheric pressure, to a volume which is close to 2.5 times the volume of the primary chamber. One thus obtains a quick recharging of the bottle, at least as long as the pressure in the bottle is not too substantial. Indeed, when the pressure reaches a certain threshold, the force to overcome for compressing the air in the outlet cavity (50) of the primary chamber is substantially increased, which is due to the large area of the cross-section of the primary chamber.

One can then open the closure valve (74) and engage in an operating mode of the pump in which the outlet cavity (50) of the primary chamber (CP) is inactivated. Therefore, it no longer resists the descending movement of the piston, such that the force to overcome (when the pistons descend) is now only that corresponding to the compression of the air in the outlet cavity of the secondary chamber (CS), which has a smaller cross-section. In this configuration, the transfer compartment and the outlet cavity (52) of the secondary chamber continue to function as described previously. This operating mode makes it possible to transfer about 1.5 times the volume of the primary chamber upon each to-and-fro motion of the pistons and, in particular, it makes it possible to reach pressures close to twenty bars in the tank.

It is noted that this second operating mode is almost identical to that described in connection with the embodiment of FIG. 2, with the only difference that the air which is admitted into the transfer compartment is no longer admitted via the outlet cavity of the primary chamber, but via the air inlet (65).

The pumping systems of FIGS. 2 and 4 are therefore particularly well adapted to the charging of an air tank adapted to underwater diving, including a tank adapted to remain on the surface of the water, as in the case of “hookah”-type apparatuses. Indeed, they make it possible (due to the two bodies) to recharge the tank between two dives in a very short period of time and with moderate effort. Moreover, they make it possible to obtain a sufficiently high pressure in the tank (due to the two steps of compression) for storing a substantial amount of air in the tank, enabling the diver to remain submerged for a longer period of time.

1. Subaquatic self-contained breathing apparatus (15) including a bottle (1) and a carrying system adapted to fit in particular on the back of a diver, characterized in that it comprises a manual pump system integrated into the bottle (1).

2. Subaquatic self-contained breathing apparatus (15) according to claim 1, characterized in that the integrated manual pump comprises a single body (37).

3. Subaquatic self-contained breathing apparatus (15) according to claim 2, characterized in that the admission of air into the pump body (37) is carried out through the piston holding rod (31) due to a first opening (27) emerging above the piston (34) and a second opening (28) positioned substantially at the upper end of the rod and performing the air intake.

4. Subaquatic self-contained breathing apparatus (15) according to claim 1, characterized in that the integrated manual pump is a pump with multiple compression stages.

5. Subaquatic self-contained breathing apparatus (15) according to claim 4, characterized in that the integrated manual pump comprises two bodies demarcating a primary chamber (18) and a secondary chamber (19), each of which houses a piston (17, 16).

6. Subaquatic self-contained breathing apparatus (15) according to claim 5, characterized in that the pistons are driven simultaneously in a to-and-fro motion within the primary (CP) and secondary (CS) chambers.

7. Subaquatic self-contained breathing apparatus, characterized in that the primary chamber (CP) and the secondary chamber (CS) are functionally arranged in series.

8. Subaquatic self-contained breathing apparatus (15) according to claim 7, characterized in that the admission of air into the primary chamber (18) is carried out through the piston holding rod (4) which is hollow, and which has a lower opening emerging beneath the piston (17) and an upper opening (26), performing the air intake, positioned substantially at its upper end.

9. Subaquatic self-contained breathing apparatus (15) according to claim 8, characterized in that the two primary (CP) and secondary (CS) chambers are in communication with one another by their upper end.

10. Subaquatic self-contained breathing apparatus (15) according to one of claim 3 or 8, characterized in that the upper opening (26, 28) for air intake is positioned on the piston holding rod (4, 31) at the level of or beneath a sealing joint (23, 32) when the rod (4, 31) is completely retracted into the pump body (18, 37).

11. Subaquatic self-contained breathing apparatus (15) according to any one of the preceding claims, characterized in that it comprises a charge and discharge valve (8).

12. Subaquatic self-contained breathing apparatus (15) according to any one of the preceding claims, characterized in that it comprises a system of telescopic or foldable feet (13) and (14).

13. Subaquatic self-contained breathing apparatus (15) according to any one of the preceding claims, characterized in that it comprises a system (30) for locking the pump.

14. Underwater self-contained breathing apparatus (1) according to any one of the preceding claims, characterized in that it includes an air supply hose (10) connected to the bottle (1) by a quick coupler (9), and in that the hose (10) is coupled to a pressure reducing valve (12) at its other end.

15. Underwater self-contained breathing apparatus (1) according to any of the preceding claims, characterized in that it includes an instrument (7) for measuring the internal pressure of the bottle.

16. Underwater self-contained breathing apparatus (1) according to claim 1, characterized in that the carrying system comprises shoulder straps (32a, 32b).

17. Underwater self-contained breathing apparatus (1) according to claim 1, characterized in that it includes a depth checking device that reduces the air flow of the pressure reducing valve from a predetermined depth.

18. Self-contained breathing apparatus according to claim 6, characterized in that the pistons (46, 48) demarcate an outlet cavity (50, 52) and a transfer cavity (62, 64) in each of the two chambers (CP, CS), and in that each of the two chambers comprises an air outlet opening (54, 56) provided in the outlet cavity (50, 52), which opens out in the bottle.

19. Self-contained breathing apparatus according to claim 18, characterized in that each outlet opening (54, 56) is associated with a non-return system (58, 60) allowing the passage of air only from the outlet cavity (50, 52) toward the inside of the bottle.

20. Self-contained breathing apparatus according to one of claim 18 or 19, characterized in that the outlet cavity (50) of the primary chamber (CP) comprises a vent tube (72) provided with blocking means (74).

21. Self-contained breathing apparatus according to one of claims 18-20, characterized in that the outlet cavity (50) of the primary chamber (CP) comprises an air admission pipe (68) that is connected to the outside, and which is associated with a non-return system (70) allowing passage of the air only from the outside toward the outlet cavity (50).

22. Self-contained breathing apparatus according to any one of claims 18-21, characterized in that the transfer cavities (62, 64) of the two chambers (CP, CS) are connected by a connecting channel so as to form a transfer compartment.

23. Self-contained breathing apparatus according to claim 22, characterized in that the transfer compartment comprises an air admission inlet (65) that is connected to the outside, and which is associated with a non-return system (67) allowing passage of the air only from the outside toward the transfer compartment.

24. Self-contained breathing apparatus according to any one of claims 18-23, characterized in that the secondary chamber (CS) comprises means (16a, 76, 78) allowing for the unidirectional passage of the air from its transfer cavity (64) toward its outlet cavity (52).

25. Self-contained breathing apparatus according to any one of claims 18-24, characterized in that the pump comprises two stages of compression.

26. Self-contained breathing apparatus according to any one of claims 18-25, characterized in that it comprises means for deactivating one of the outlet cavities.
